(19) United States
(12) Patent Application Publication
(10) Pub. No.: US 2014/0030629 A1
(43) Pub. Date: Jan. 30, 2014

(54) SOLID OXIDE FUEL CELL

(71) Applicant: SAMSUNG ELECTRO-MECHANICS CO., LTD., Suwon (KR)

(72) Inventors: Kyong Bok Min, Suwon (KR); Bon Seok Koo, Suwon (KR); Jai Hyoung Gil, Suwon (KR)

(73) Assignee: SAMSUNG ELECTRO-MECHANICS CO., LTD., Suwon (KR)

(21) Appl. No.: 13/717,642

(22) Filed: Dec. 17, 2012

(30) Foreign Application Priority Data
Jul. 24, 2012 (KR) 10-2012-0080654

(51) Int. Cl. H01M 8/02; H01M 8/12

(52) U.S. Cl. CPC H01M 8/0276; H01M 8/1246
USPC 429/488

(57) ABSTRACT

Disclosed herein is a solid oxide fuel cell including a unit cell including an anode, an electrode, and a cathode; a separation plate including channels formed on an upper or lower surface thereof so as to supply gas and disposed in parallel with each other by a predetermined interval; and a plurality of sealing members disposed between the unit cell and the separation plate, wherein the sealing member includes a glass sheet and paste layers applied to both surfaces of the glass sheet.

### CROSS REFERENCE TO RELATED APPLICATION

This application claims the benefit of Korean Patent Application No. 10-2012-0080654, filed on Jul. 24, 2012, entitled “Solid Oxide Fuel Cell”, which is hereby incorporated by reference in its entirety into this application.

### BACKGROUND OF THE INVENTION

1. Technical Field

The present invention relates to a solid oxide fuel cell.

2. Description of the Related Art

Generally, a fuel cell is a device directly converting chemical energy of fuel (hydrogen, liquefied natural gas (LNG), liquefied petroleum gas (LPG), or the like) and oxygen (air) into electrical and thermal energy by an electrochemical reaction. The existing power generation technologies should perform processes such as fuel combustion, steam generation, turbine driving, generator driving, or the like, while the fuel cell does not need to perform processes such as fuel combustion, turbine driving, or the like. As a result, the fuel cell is a new power generation technology capable of increasing power generation efficiency without causing environmental problems. The fuel cell minimally discharges air pollutants such as SOₓ, NOₓ, or the like, and generates less carbon dioxide, such that chemical-free, low-noise, non-vibration power generation, or the like, may be implemented.

There are various types of fuel cells such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), or the like. Among them, the solid oxide fuel cell (SOFC) depends on activation polarization, which lowers over-voltage and irreversible loss to increase power generation efficiency. Further, since the reaction rate in electrodes is rapid, the SOFC does not need to use expensive precious metals as an electrode catalyst. Therefore, the solid oxide fuel cell is an essential power generation technology in order to enter a hydrogen economy society in the future.

Patent Document 1 discloses a flat plate type solid oxide fuel cell, wherein the flat plate type to solid oxide fuel cell includes a unit cell between two separation plates. The unit cell is configured of an anode, an electrolyte, and a cathode as widely-known to those skilled in the art. The separation plate in Patent Document 1 serves to support each of the unit cells to be loaded simultaneously with physically blocking different gases flowing along channels formed at both sides of the separation plate, for example, air supplied to the cathode and fuel gas supplied to the anode. In addition, an outer peripheral sealing member is formed between the separation plate and the unit cell. Here, since this outer peripheral sealing member is used at a high temperature, it is not easy to separate the separation plate, and it is impossible to reuse the separation plate.

Further, in the separation plate in Patent Document 1, an internal structure thereof may be deformed by thermal and/or chemical reaction between the separation plate and the unit cell directly contacting each other at the time of assembly of the stack to deteriorate durability, and when the cell is operated for a long period time in this state, the cell and the stack are damaged, such that the cell may not be operated.

[Prior Art Document]

[Patent Document]

### (Patent Document 1) Korean Patent Laid-open Publication No. 10-2000-0059873

### SUMMARY OF THE INVENTION

The present invention has been made in an effort to provide a solid oxide fuel cell capable of easily separating a separation plate and/or a unit cell from a stack.

As described above, an object of the present invention is to provide a sealing member sealing between the unit cell and the separation plate, and the solid oxide fuel cell stacked to form a stack using the sealing member.

According to a preferred embodiment of the present invention, there is provided a solid oxide fuel cell including: at least one unit cell including an anode, an electrode, and a cathode; at least one separation plate including channels formed on an upper or lower surface thereof so as to supply gas and disposed in parallel with each other by a predetermined interval; and a plurality of sealing members including a glass sheet and paste layers applied to both surfaces of the glass sheet, wherein the sealing member is disposed between the unit cell and the separation plate to block the gas to be supplied to the separation plate from being leaked to the outside. Both surfaces of the glass sheet may have a flat plate shape and allow the separation plate and the unit cell to be closely adhered to each other.

The sealing member may be disposed at an edge of the unit cell and an edge of the separation plate.

In addition, the sealing member may be arranged in a direction parallel with a formation direction of the channel of the separation plate at the edge of both sides of the separation plate facing each other in parallel with each other.

In addition, the sealing member may be disposed along a circumference of an edge of the separation plate.

Particularly, the solid oxide fuel cell according to the present invention may be separably stacked by assisting in sliding movement between the constituent members by means of the sealing member including paste layers applied to both surfaces thereof The sealing member may have electric insulating property.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic cross-sectional view of a sealing member according to a preferred embodiment of the present invention;

FIG. 2 is an exploded perspective view of a solid oxide fuel cell using the sealing member according to the preferred embodiment of the present invention; and

FIG. 3 is a perspective view of the solid oxide fuel cell stacked using a stack shown in FIG. 2.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

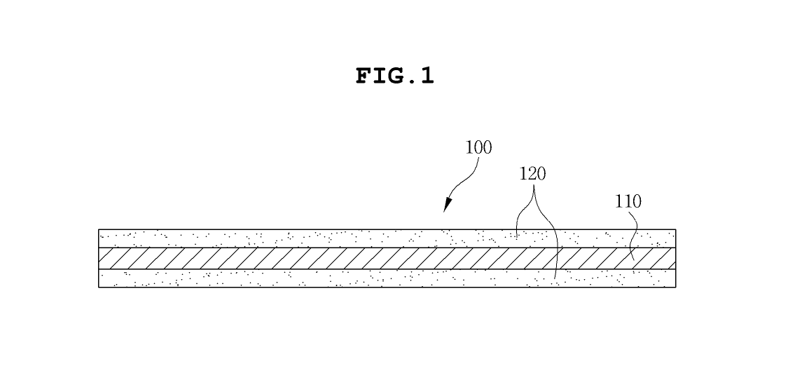

FIG. 1 is a schematic cross-sectional view showing a sealing member according to a preferred embodiment of the present invention.

As shown in FIG. 1, the sealing member 100 according to the preferred embodiment of the present invention includes a glass sheet 110 and paste layers 120 on both surfaces of the glass sheet 100. A solid oxide fuel cell needs to be supplied with air, hydrogen, or the like, in order to generate electric energy. However, when the supplied air or hydrogen is leaked or air and hydrogen are mixed with each other in the solid oxide fuel cell, power generation efficiency is rapidly reduced, and the solid oxide fuel cell may be damaged due to rapid power generation or explosion caused by oxidation reaction of hydrogen. Therefore, the solid oxide fuel cell uses the sealing member in order to prevent air or hydrogen from being leaked or prevent air and hydrogen from being mixed with each other.

Particularly, the glass sheet 110 is a support of the sealing member 100, having thermal expansion coefficient similar to those of constituent members configuring the solid oxide fuel cell.

Since the sealing member 100 includes the glass sheet 110 having the thermal expansion coefficient similar to those of constituent members configuring the solid oxide fuel cell as described above, cracks and damage by thermal stress between several constituent members of the solid oxide fuel cell may be prevented in advance, and thermal impact may be minimized when operation of the solid oxide fuel cell is suddenly stopped. In addition, the sealing member 100 should not permeate into a porous electrode contacting the sealing member 100 as well as maintaining constant sealing property in thermal cycle applied during the operation of the solid oxide fuel cell, and unnecessary chemical reaction should not occur therein under oxidizing and/or reducing atmosphere. Further, the sealing member needs to have electrical resistivity increased at a high operation temperature to maintain electrical insulation.

The paste layers 120 according to the preferred embodiment of the present invention are to applied to upper and lower flat surfaces of the glass sheet 110 as shown in FIG. 1 and directly contact the constituent members of the solid oxide fuel cell.

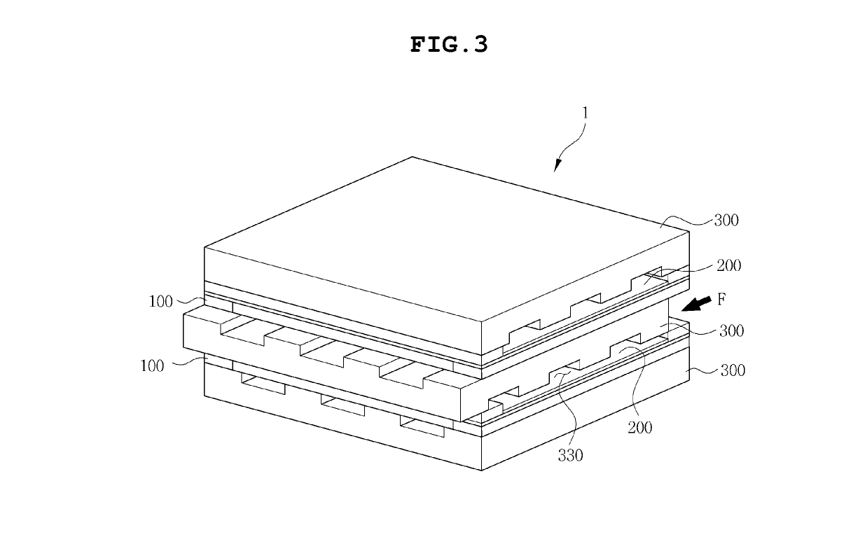

The paste layer 120 acts as an adhesive closely adhering the sealing member 100 and the constituent members of the solid oxide fuel cell to each other but is not hardened (See FIG. 3), such that the sealing member 100 and the constituent members of the solid oxide fuel cell that are loaded in a stack state may be easily separated from each other by predetermined external force.

As described above, since the sealing member 100 applied with the paste layer 120 is not firmly adhered and fixed to each of the constituent members of the solid oxide fuel cell to be loaded in the stack state, thermal stress generated at the time of rapidly cooling the sealing member 100 melted and adhered to the constituent members of the solid oxide fuel cell or generated according to repeated heating/cooling cycle does not cause harmful influence on the glass sheet 110, and in the case in which the sealing member is exposed at a high temperature of 600° C. or more for a long period time, sealing property inhibiting factor due to structural weakness of the glass sheet 110 and the paste layer 120 may be prevented in advance.

In other words, in the sealing member 100 according to the preferred embodiment of the present invention, the paste layer 120 is applied to both surfaces of the glass sheet 110, such that thermal stress may be reduced to prevent the glass sheet 110 from being damaged and the sealing member 100 may be easily attached to and detached from the solid oxide fuel cell by means of the paste layer 120, thereby making it possible to detect problems such as performance degradation at any time.

Preferably, the paste layer 120 may be made of compressible paste so that the paste may be compressed by the load of the solid oxide fuel cell in the stack state even at a high temperature of 600° C. to certainly adhere each of the constituent members thereto while maintaining the sealing property.

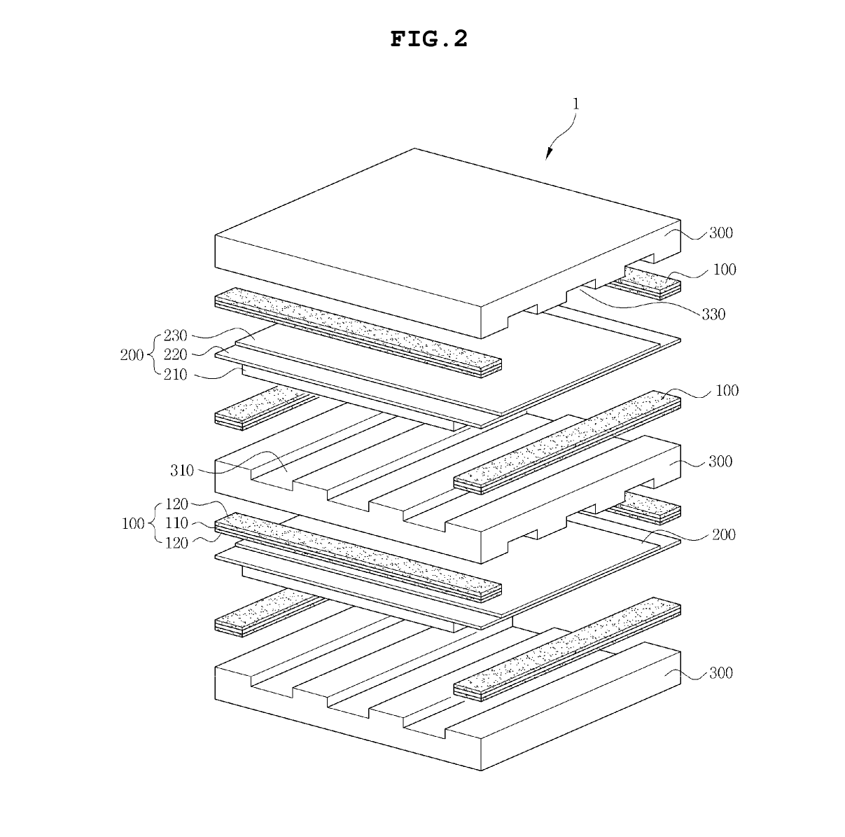

FIG. 2 is an exploded perspective view of a solid oxide fuel cell using the sealing member according to the preferred embodiment of the present invention and FIG. 3 is a perspective view schematically showing the solid oxide fuel cell shown in FIG. 2.

The solid oxide fuel cell 1 according to the preferred embodiment of the present invention shown in FIGS. 2 and 3, which is a flat plate type solid oxide fuel cell, includes a unit cell 200 in which an anode 210, an electrode 220, and a cathode 230 that are formed in a flat plate shape are stacked. However, the present invention is not limited thereto, but may be applied to a flat plate type or cylindrical type solid oxide fuel cell.

More specifically, the solid oxide fuel cell 1 according to the present invention is configured to include sealing members 100, at least one unit cell 200, and at least one separation plate 300.

Particularly, the separation plate 300 includes channels 310 and 330 capable of supplying gases to the unit cell 200.

Here, the term “separation plate” basically means a constituent member capable of electrically connecting an anode of a unit cell to a cathode of another unit cell arranged to be adjacent to each other but physically blocking air supplied to the cathode from fuel gas supplied to the anode. Therefore, the separation plate is called “inter-connector” in a sense of electrically connecting unit cells to each other or called “separator” in a sense of physically separate the unit cells from each other. In the present specification, for assisting in clear understanding, the term “separation plate” will be coherently used.

In addition, the sealing member 100 according to the present invention may be made of an electrically insulating material in order to assist in insulating between the unit cell 200 and the separation plate 300.

The unit cell 200 serves to generate electric energy and is formed by stacking the anode 210, the electrolyte 220, and the cathode 230 therein as described above. Generally, in the solid oxide fuel cell 1 (SOFC), when fuel gas is hydrogen (H2) or carbon monoxide (CO), the following electrode reaction is performed in the anode 210 and the cathode 230.

Anode: CO+H₂O'H₂+CO₂

2H₂+2O²⁻→+4e⁻+2H₂O

Cathode: O₂+4e⁻→2O²⁻

Entire reaction: H₂+CO+O₂→CO₂+H₂O

That is, electrons (e) generated in the anode 210 are transferred to the cathode 230 through an external circuit (not shown) and at the same time, oxygen ions (O²) generated in the cathode 230 are transferred to the anode 210 through an electrolyte 220. In the anode 210, hydrogen is bonded to oxygen ions to generate electrons and water. As a result, reviewing the entire reaction of the solid oxide fuel cell, hydrogen (H₂) or carbon monoxide (CO) are supplied to the anode 210 and oxygen is supplied to the cathode 230, such that carbon dioxide (CO₂) and water (H₂O) are generated.

The anode 210 receives fuel from the fuel channel 310 of the separation plate 300 to serve as an anode through an electrode reaction. Selectively, the anode 210 is configured of nickel oxide (NiO) and yttria stabilized zirconia (YSZ), wherein nickel oxide (NiO) is reduced to metallic nickel by hydrogen to ensure electron conductivity, and yttria stabilized zirconia (YSZ) ensures ion conductivity as oxide.

The electrolyte 220, which is a medium transferring oxygen ions generated in the cathode 230 to the anode 210, may be formed by sintering yttria stabilized zirconia or scandium stabilized zirconia (ScSZ), gadolinia-doped ceria (GDC), La₂O₃-Doped CeO₂ (LDC), or the like. For reference, since tetravalent zirconium ions are partially substituted with trivalent yttrium ions in the yttria stabilized zirconia, one oxygen hole per two yttrium ions is generated therein, and oxygen ions move through the hole at a high temperature. In addition, when pores are generated in the electrolyte 220, since a crossover phenomenon of directly reacting fuel with oxygen (air) may be generated to reduce efficiency, it needs to be noted so that a scratch is not generated.

The cathode 230 receives oxygen or air from the air channel 330 of the separation plate 300 to serve as a cathode through an electrode reaction. Here, the cathode 230 may be formed by sintering lanthanum strontium manganite ((La_{0.84} Sr_{0.16}) MnO₃) having high electron conductivity, or the like. Meanwhile, in the cathode 230, oxygen is converted into oxygen ion by a catalytic reaction of lanthanum strontium manganite to thereby be transferred to the anode 210 through the electrolyte 220.

The solid oxide fuel cell 1 according to the preferred embodiment of the present invention includes at least one unit cell 200 as shown in FIG. 2, and the case in which the solid oxide fuel cell 1 includes two unit cells 200 is shown in FIG. 2. The separation plate 300 is disposed between two unit cells 200 disposed in parallel with each other. A lower surface of the separation plate 300 contacts the cathode 230 of the unit cell 200 under oxidizing atmosphere, and an upper surface of the separation plate 300 contacts the anode 210 under reducing atmosphere as shown in FIG. 2.

Selectively, the separation 300 may be made of ferritic stainless steel.

The sealing member 100 according to the present invention seals the gap between the flat plate type unit cell 200 and the separation plate 300 as shown in FIG. 2. More specifically, the sealing members 100 are provided between edges of the unit cells 200 arranged in parallel with each other and edges of the separation member 300. The sealing member 100 is made of a glass sheet 110 and includes paste layers 120 applied to both surfaces of the glass sheet 110.

Preferably, the sealing member 100 according to the preferred embodiment of the present invention may be disposed between edges of the upper surface of the separation plate 300 and edges of a lower surface of the unit cell 200 in a direction parallel with a formation direction of the fuel channel 310 so as to prevent the fuel gas to be guided to the fuel channel 310 of the separation plate 300 from being leaked to the outside. In addition, the sealing member 100 may be disposed between edges of the lower surface of the separation plate 300 and edges of an upper surface of the unit cell 200 in a direction parallel with a formation direction of the air channel 330 so as to prevent the air to be guided to the air channel 330 of the separation plate 300 from being leaked to the outside.

The sealing member 100 is not disposed in directions parallel with the formation directions of the channels 310 and 330 as described above, but may be disposed along circumferences of the edges of the unit cell 200 and the separation plate 300 so as to be completely sealed.

In the solid oxide fuel cell 1 according to the present invention stacked to form a stack schematically shown in FIG. 3, the sealing member 100 applied with the paste layer is arranged between at least one separation plate 300 and at least one unit cell 200. Referring to FIG. 1, the sealing member 100 according to the present invention is configured of the glass sheet and the paste layers applied to both surfaces thereof, but in order to easily distinguish each of the constituent members in the stack state, the state in which the sealing member 100 is not subdivided into the glass sheet and the paste layer is shown in FIG. 3.

According to the present invention, boundary surfaces between the sealing member 100 and the unit cell 200 and boundary surfaces between the sealing member 100 and the separation plate 300 are disposed to contact each other, such that the unit cell 200 and the separation plate 300 are closely adhered to each other while maintaining sealing property via the paste layer of the sealing member 100. In other words, the paste layer of the sealing member 100 is compressed by the load of the solid oxide fuel cell stacked to form the stack to adhere each of the constituent members, thereby maintaining the sealing property.

In addition, in the solid oxide fuel cell 1 stacked to form the stack according to the present invention, when shearing force is applied thereto through predetermined external force F, the paste layers filled on the boundary surfaces between the sealing member 100 and the separation plate 300 and/or the boundary surfaces between the sealing member 100 and the unit cell 200 are deformed so as to be staggered, such that each of the constituent members may slide through the paste layer of the sealing member 100, thereby making it possible to be easily separated from each other even in the stack state.

As set forth above, according to the present invention, the unit cell and the separation plate may be easily separated from each other in the solid oxide fuel cell stacked to form the stack.

That is, according to the present invention, since the unit cell and the separation plate may be easily separated from each other as described above, a unit cell of which performance is degraded and/or a separation plate may be easily removed and replaced, thereby reducing cost.

In addition, the present invention suggests a more effective sealing structure between the anode and separation plate and between the cathode and separation plate, thereby making it possible to improve durability of the solid oxide fuel cell.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell comprising:
a unit cell including an anode, an electrode, and a cathode;
a separation plate including channels formed on an upper or lower surface thereof so as to supply gas and disposed in parallel with each other by a predetermined interval; and
a plurality of sealing members including a glass sheet and paste layers applied to both surfaces of the glass sheet and disposed between the unit cell and the separation plate to block the gas to be supplied to the separation plate from being leaked to the outside.

2. The solid oxide fuel cell as set forth in claim 1, wherein the sealing member is disposed at an edge of the unit cell and an edge of the separation plate.

3. The solid oxide fuel cell as set forth in claim 1, wherein the sealing member is arranged in a direction parallel with a formation direction of the channel of the separation plate.

4. The solid oxide fuel cell as set forth in claim 1, wherein the sealing member is disposed along a circumference of an edge of the separation plate.

5. The solid oxide fuel cell as set forth in claim 1, wherein the sealing member is separably stacked via the paste layer.

6. The solid oxide fuel cell as set forth in claim 1, wherein the sealing member has electric insulating property.

7. The solid oxide fuel cell as set forth in claim 1, wherein the sealing member is applied with a compressive paste layer.

8. The solid oxide fuel cell as set forth in claim 1, wherein both surfaces of the glass sheet are formed to be flat.
